(19) United States
(12) Patent Application Publication
(10) Pub. No.: US 2020/0117022 A1
(43) Pub. Date: Apr. 16, 2020

(54) OPTICAL FILM, MOLD AND ELECTRONIC DEVICE COVER PLATE

(71) Applicant: Shine Optoelectronics (Kunshan) Co., Ltd., Kunshan City (CN)

(72) Inventors: Yulong Gao, Kunshan City (CN); Shen Hong, Kunshan City (CN); Su Shen, Kunshan City (CN); Hongwei Kang, Kunshan City (CN)

(21) Appl. No.: 16/713,248

(22) Filed: Dec. 13, 2019

Related U.S. Application Data
(63) Continuation of application No. PCT/CN2018/090763, filed on Jun. 12, 2018.

(30) Foreign Application Priority Data
Jun. 27, 2017 (CN) 201710501752

(51) Int. Cl. G02B 30/40; B29D 11/00

(52) U.S. Cl. CPC G02B 30/40; B29D 11/00788

(57) ABSTRACT

The present disclosure discloses an optical film, a mold and an electronic device cover plate, wherein the optical film comprises: a carrier; a patterned layer located on a surface of the carrier, the patterned layer comprising continuously disposed micro-nano structures, which are convex structures and/or concave structures; wherein the optical film visually has a stereoscopic impression not less than 1 mm in depth or height. The optical film provided by the present disclosure is disposed with a patterned layer comprising continuously disposed micro-nano structures, so that the stereoscopic effect can be achieved only by adopting the one-layer structure, and there is a visual difference of at least 1 mm in depth or height, thereby reducing the thickness and the manufacturing process of the film, and well decreasing the cost.

### CROSS-REFERENCE TO RELATED APPLICATION

This application is a continuation of International Application No. PCT/CN2018/090763, filed on Jun. 12, 2018, which claims priority to Chinese Patent Application No. 201710501752.X filed on Jun. 27, 2017, both of which are hereby incorporated by reference in their entireties.

### TECHNICAL FIELD

The present disclosure relates to the technical field of optical films, and in particular to an optical film, a mold and an electronic device cover plate.

### BACKGROUND ART

With the development of technology, the decorative film is widely used on a surface of an electronic product such as a mobile phone or a computer, a surface of a household appliance such as a refrigerator, an air conditioner or a washing machine, a surface of an automobile, and a surface of any other similar product.

The existing decorative film is used as a surface material of a mobile machine such as a mobile phone or a notebook computer, and a surface material for molding a household appliance such as a refrigerator, a washing machine or an air conditioner, although it is used to reflect a variety of patterns and metal textures by gravure printing.

At present, the decorative film used in a 3C product or a household appliance is generally a planar structure and the visual effect is also a planar effect, thus, a housing or a cover plate of the 3C product or the household appliance is relatively simple. On the other hand, an imaging film is used on the 3C product or the household appliance, and it has a two-layer structure, which increases a thickness of the imaging film, so the process is complicated and the cost is increased. Therefore, it is necessary to provide a new technical solution to solve the technical problems.

### SUMMARY OF THE INVENTION

On this basis, it is necessary to provide an optical film, a mold for preparing the optical film, and an electronic device cover plate to solve the above technical problems.

One technical solution of the present disclosure is:

An optical film, comprising:

a carrier;

a patterned layer located on a surface of the carrier, the patterned layer comprising continuously disposed micro-nano structures which are convex structures and/or concave structures;

wherein, the optical film visually has a stereoscopic impression not less than 1 mm in depth or height.

In one embodiment, the carrier and the patterned layer are an integral structure.

In one embodiment, a bonding layer is disposed between the carrier and the patterned layer.

In one embodiment, the patterned layer is formed directly on a surface of the carrier.

In one embodiment, a reflective layer is further configured, the reflective layer is disposed on a surface of the patterned layer, and the reflective layer covers or partially covers the micro-nano structure.

In one embodiment, a colored layer is further configured, the colored layer is disposed on a surface of the reflective layer, and the colored layer covers the reflective layer.

In one embodiment, in the continuously disposed micro-nano structures, there exist at least adjacent micro-nano structure units having different heights and/or widths.

In one embodiment, a difference in heights and/or widths of the adjacent micro-nano structure units is in a principle of gradual variation.

In one embodiment, the patterned layer comprises a plurality of continuously disposed micro-nano structure regions, and the micro-nano structures in adjacent two of the micro-nano structure regions have different parameters of one or combinations of more than two of height, width and density.

In one embodiment, a difference in the parameters is a principle of gradual variation.

In one embodiment, the micro-nano structure is one or combinations of more than two of a cylindrical lens, a micro-lens, a CD pattern, a continuous fluctuant wave shape, a drawing line or a Fresnel lens.

A mold for preparing an optical film, comprising:

a base material;

a carrier disposed on a surface of the base material;

a patterned layer located on a surface of the carrier away from the base material, the patterned layer comprising continuously disposed micro-nano structures which are convex structures and/or concave structures.

In one embodiment, a shielding structure is disposed between the base material and the carrier.

An electronic device cover plate, comprising any of the aforementioned optical films.

In one embodiment, a support is further comprised, wherein the optical film is located on one side of the support, and the support is made of glass, organic glass, metal, hard plastic or sapphire.

In one embodiment, a housing is further comprised, to which the optical film is connected through a bonding layer.

### The Advantageous Effects of the Present Disclosure

(I) An optical film provided by the present disclosure is disposed with a patterned layer comprising continuously disposed micro-nano structures, so that the stereoscopic effect can be achieved only by adopting the one-layer structure, and there is a visual difference of at least 1 mm in depth or height, thereby reducing the thickness and the manufacturing process of the film, and well decreasing the cost.

(II) The present disclosure further provides a mold for preparing an optical film and an electronic device cover plate using the optical film, so that the optical film can be prepared in batches by the mold to increase the yield. The electronic device cover plate using the optical film achieves a stereoscopic effect visually.

### BRIEF DESCRIPTION OF THE DRAWINGS

FIG. 1 illustrates a schematic structural diagram of an optical film according to the present disclosure;

FIG. 2 illustrates another schematic structural diagram of an optical film according to the present disclosure;

FIG. 3 illustrates still another schematic structural diagram of an optical film according to the present disclosure;

FIG. 4 illustrates still another schematic structural diagram of an optical film according to the present disclosure;

FIG. 5 illustrates still another schematic structural diagram of an optical film according to the present disclosure;

FIG. 6 illustrates still another schematic structural diagram of an optical film according to the present disclosure;

FIG. 7 illustrates still another schematic structural diagram of an optical film according to the present disclosure;

FIG. 8 illustrates a schematic structural diagram of an optical film including a reflective layer and a colored layer according to the present disclosure;

FIG. 9 illustrates a schematic structural diagram of an electronic device cover plate according to the present disclosure.

### DETAILED DESCRIPTION OF THE PREFERRED EMBODIMENTS

In order to facilitate the understanding of the present disclosure, the present disclosure will be described more completely as follows with reference to the drawings. Preferred embodiments of the present disclosure are illustrated in the drawings. However, the present disclosure can be implemented in many different forms and it is not limited to the embodiments described below. Rather, these embodiments are provided so that the present disclosure can be understood more thoroughly and completely.

To be noted, when an element is referred to as being ‘disposed on’ another element, it may be directly on another element or an intermediate element may be present. When an element is considered to be ‘connected to’ another element, it may be directly connected to another element or an intermediate element may be present. The terms ‘vertical’, ‘horizontal’, ‘left’, ‘right’, and the like used herein are merely for the purpose of illustration, rather than indicating an unique embodiment.

All of the technical and scientific terms used herein have the same meanings commonly understood by those skilled in the art of the present disclosure, unless otherwise defined. Herein, the terms used in the specification of the present disclosure are only for the purpose of describing the particular embodiments, rather than being intended to limit the present disclosure. The term ‘and/or’ used herein includes any and all combinations of one or more of the related listed items.

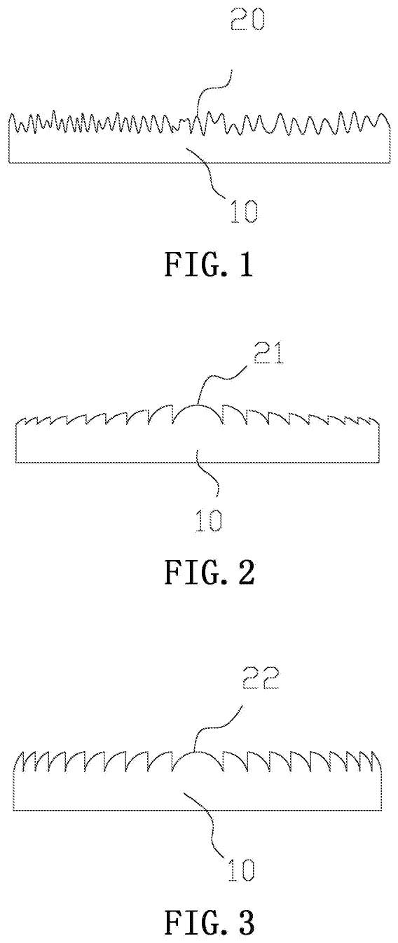

Referring to FIG. 1, an optical film comprises:

a carrier 10, which may be a thermo-curing or photo-curing adhesive, such as UV; of course, the carrier 10 may be a colored thermo-curing or photo-curing adhesive, or a colored polymer;

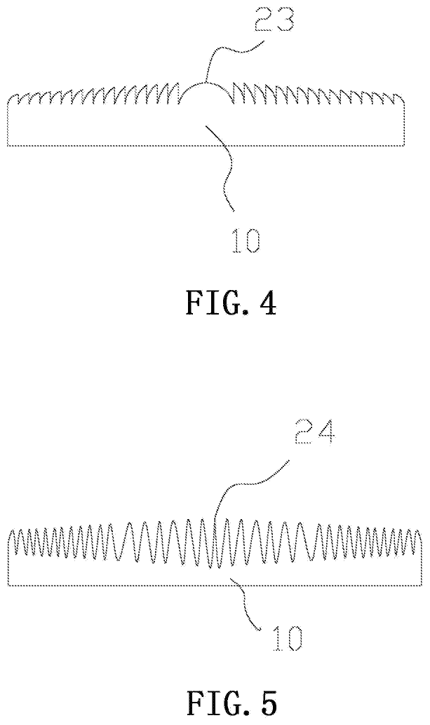

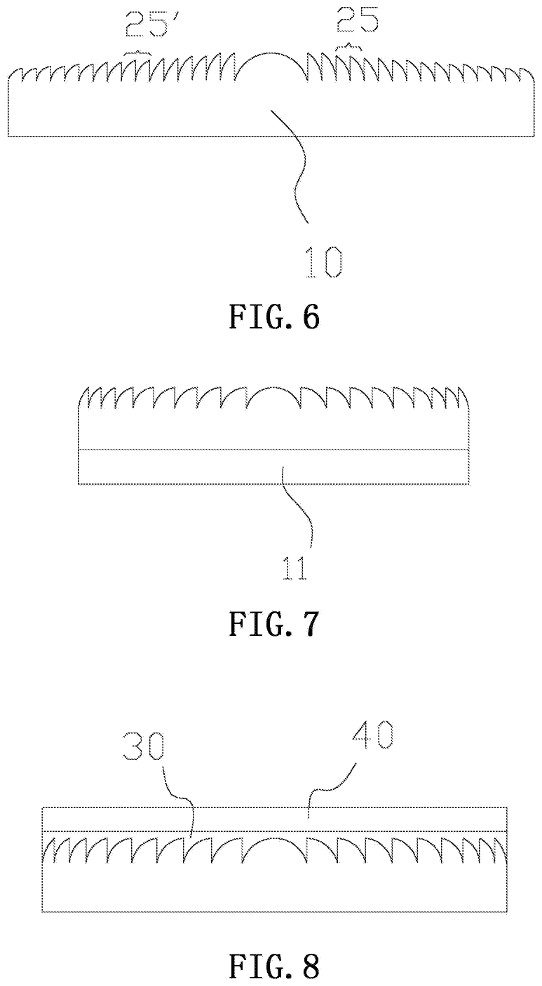

a patterned layer located on a surface of the carrier 10 and formed by a process such as imprinting, photo-etching, or scribing on a side of the carrier 10, so that the structure has a height and/or depth; thus, one side of the carrier 10 having such structure is referred to as a patterned layer, comprising continuously disposed micro-nano structures 20 which are convex-concave structures; referring to FIGS. 2, 3, 4 and 6, wherein micro-nano structures 21, 22, 23, 25 and 25′ are convex structures, and of course, the micro-nano structures may also be concave structures (not illustrated in the drawings); an interval between adjacent two of the micro-nano structures is 0, i.e., there is no gap, or an interval d between adjacent two of the micro-nano structures is 0<d≤10 μm and it further may be 0<d≤2 μm.

The optical film visually has a stereoscopic impression not less than 1 mm in depth or height.

Referring to FIGS. 1 to 5, in one embodiment, the optical film visually has a stereoscopic impression not less than 1 mm in depth or height; in the continuously disposed micro-nano structures 20 to 25 and 25′, there exist at least adjacent micro-nano structure units having different heights and/or widths, in which the height and the width of the micro-nano structure unit in each of the micro-nano structures 21 and 24 are both varied, the height of the micro-nano structure unit in the micro-nano structure 22 is unvaried while the width thereof is varied, and the width of the micro-nano structure unit in the micro-nano structure 23 is unvaried while the height thereof is varied.

Referring to FIGS. 2 to 5, in one embodiment, the difference in the heights and/or the widths of the adjacent micro-nano structure units is in a principle of gradual variation, and substantially, the micro-nano structure unit gradually varies from a certain area thereof to the surrounding; of course, the difference in the heights and/or the widths of the adjacent micro-nano structure units also may be not in the principle of gradual variation, and the heights and/or the widths may be set differently according to the optical effect to be presented.

Referring to FIG. 5, in one embodiment, the patterned layer comprises a plurality of continuously disposed micro-nano structure regions 25 and 25′, wherein micro-nano structure units in adjacent two of the micro-nano structure regions have different parameters of one or combinations of more than two of height, width and density. The micro-nano structure units in the micro-nano structure regions may have the same or different parameters, but the micro-nano structure units in the adjacent micro-nano structure regions have different average parameters. The difference in the parameters is in the principle of gradual variation. Of course, the difference in the heights and/or the widths or the densities of the micro-nano structure units also may be not in the principle of gradual variation, and the heights and/or the widths or the densities may be set differently according to the optical effect to be presented.

Referring to FIGS. 2, 3, 4 and 6, in the micro-nano structure, there are two micro-nano structure units having a height difference and/or a width difference of less than 20 μm. Referring to FIGS. 1 and 5, a difference between a peak value and a valley value of the micro-nano structure is less than 20 μm.

Referring to FIGS. 1 to 6, in one embodiment, the carrier 10 and the patterned layer are an integral structure, i.e., the micro-nano structure is directly formed on one surface of the carrier 10 without any substantive hierarchical interface therebetween.

Referring to FIG. 7, in one embodiment, the optical film is further disposed with a base material layer 11. In this case, the base material layer 11 may be made of a material the same as or different from a material of the carrier in FIGS. 1 to 6. For example, the base material layer may be made of PET, PC, glass, etc., and may be colored, i.e., the base material layer 11 comprises a colored film or a colored material on its surface, so that the base material layer is colored. The colored film or colored material may be disposed on a side close to or away from the patterned layer, or the base material layer itself may be colored. The base material layer may also be a thermo-curing or photo-curing polymer; a bonding layer is disposed between the carrier and the base material layer 11; in this case, the base material layer is not integral with the carrier, and the base material layer 11 has a support function; next, the carrier is disposed on a surface of the base material layer, the micro-nano structure is formed on a surface of the carrier away from the base material layer, and a bonding layer is further disposed between the base material layer and the carrier.

Referring to FIG. 8, in one embodiment, a reflective layer 30 is further disposed on a surface of the patterned layer to cover or partially cover the micro-nano structure. The reflective layer 30 may be made of metal or an oxide, and serves for a reflection and a color formation, so that the decorative film exhibits various desired colors. In addition, the reflective layer 30 is not an electric conductor and has an insulation effect, so that a signal of the electronic device will not be shielded. In addition, a transmittance of the reflective layer is greater than or equal to 5%, or greater than or equal to 50%, or equal to or less than 80%. A colored layer 40 is further disposed on a surface of the reflective layer 30 to cover the reflective layer 30. The colored layer 40 acts as a primer, i.e., for light blocking, and it can also cooperate with the reflective layer 30 for toning.

In one embodiment, the micro-nano structures 20 to 25 and 25′ are one or combinations of more than two of a cylindrical lens, a microlens, a CD pattern, a continuously fluctuant wave shape, a drawing line or a Fresnel lens.

A mold for preparing an optical film, comprising:

a base material;

a carrier disposed on a surface of the base material;

a patterned layer located on a surface of the carrier away from the base material, the patterned layer comprising continuously disposed micro-nano structures which are convex structures and/or concave structures.

In one embodiment, a shielding structure is disposed between the base material and the carrier.

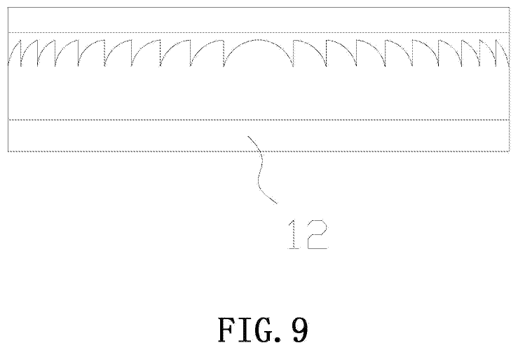

Referring to FIG. 9, an electronic device cover plate comprises the optical film illustrated in any of FIGS. 1 to 8.

In one embodiment, the carrier 12 is made of glass, organic glass, metal, hard plastic or sapphire, in which case, the carrier is not integral with the patterned layer.

In one embodiment, a housing is further comprised, to which the optical film illustrated in any of FIGS. 1 to 8 is connected through a bonding layer; wherein the carrier in FIG. 7 is one or combinations of more than two of PET, PC, PMMA or PE.

In order that the objectives, features and advantages of the present disclosure are more apparent and understandable, the particular embodiments of the present disclosure are described in detail as above with reference to the drawings. Numerous details are set forth in the above descriptions in order to fully understand the present disclosure. However, the present disclosure can be implemented in many other ways different from those described above, and those skilled in the art can make similar modifications without departing from the spirit of the present disclosure. Thus, the present disclosure is not limited by the particular embodiments disclosed above. Moreover, the technical features of the above embodiments may be arbitrarily combined. In order for concise descriptions, all possible combinations of the various technical features in the above embodiments are not described. However, the combinations of these technical features should be considered to fall within the scope of the present specification as long as there is no contradiction therebetween.

Those described above merely illustrate several embodiments of the present disclosure, and the descriptions thereof are relatively specific and detailed, but should not be construed as limitations to the scope of this invention patent. It should be noted that a number of variations and modifications may be made by those skilled in the art without departing from the invention concept, and they all fall within the protection scope of the present disclosure. Therefore, the protection scope of this invention patent should be determined by the appended claims.

1. An optical film, comprising:
a carrier;
a patterned layer located on a surface of the carrier, the patterned layer comprising continuously disposed micro-nano structures which are convex structures and/or concave structures;
wherein, the optical film visually has a stereoscopic impression not less than 1 mm in depth or height.

2. The optical film according to claim 1, wherein the carrier and the patterned layer are an integral structure.

3. The optical film according to claim 1, further comprising a base material layer, and a bonding layer is disposed between the carrier and the base material layer.

4. The optical film according to claim 1, wherein the patterned layer is formed directly on a surface of the carrier.

5. The optical film according to claim 1, further comprising a reflective layer disposed on a surface of the patterned layer and the reflective layer covering or partially covering the micro-nano structure.

6. The optical film according to claim 5, further comprising a colored layer disposed on a surface of the reflective layer, and the colored layer covering the reflective layer.

7. The optical film according to claim 1, wherein in the continuously disposed micro-nano structures, there exist at least adjacent micro-nano structure units having different heights and/or widths.

8. The optical film according to claim 7, wherein a difference in heights and/or widths of the adjacent micro-nano structure units is in a principle of gradual variation.

9. The optical film according to claim 1, wherein the patterned layer comprises a plurality of continuously disposed micro-nano structure regions, and the micro-nano structures in adjacent two of the micro-nano structure regions have different parameters of one or combinations of more than two of height, width and density.

10. The optical film according to claim 9, wherein a difference in the parameters is in a principle of gradual variation.

11. The optical film according to claim 1, wherein the micro-nano structure is one or combinations of more than two of a cylindrical lens, a micro-lens, a CD pattern, a continuous fluctuant wave shape, a drawing line or a Fresnel lens.

12. A mold for preparing an optical film, comprising:
a base material;
a carrier disposed on a surface of the base material;
a patterned layer located on a surface of the carrier away from the base material, the patterned layer comprising continuously disposed micro-nano structures which are convex structures and/or concave structures.

13. The mold for preparing the optical film according to claim 12, wherein a shielding structure is disposed between the base material and the carrier.

14. An electronic device cover plate, comprising the optical film according to any one of claim 1.

15. The electronic device cover plate according to claim 14, further comprising a support, wherein the optical film is located on one side of the support, and the support is glass, organic glass, metal, hard plastic or sapphire.

16. The electronic device cover plate according to claim 14, further comprising a housing, to which the optical film is connected through a bonding layer.
